(19) United States
(12) Patent Application Publication
(10) Pub. No.: US 2025/0030574 A1
(43) Pub. Date: Jan. 23, 2025

(54) COMMUNICATION METHOD AND APPARATUS, ELECTRONIC DEVICE, AND COMPUTER-READABLE STORAGE MEDIUM

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Junjie ZHAO, Beijing (CN); Shaobei CHEN, Beijing (CN); Jing SU, Beijing (CN); Hongbo FENG, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 18/712,562

(22) PCT Filed: Jul. 13, 2022
(86) PCT No.: PCT/CN2022/105479

§ 371 Date: May 22, 2024

(30) Foreign Application Priority Data
Nov. 26, 2021 (CN) 202111424081.4

(51) Int. Cl. H04L 12/28; H04L 9/40

(52) U.S. Cl. CPC H04L 12/2832; H04L 12/2834; H04L 63/08

(57) ABSTRACT

A communication method, a communication apparatus, an electronic device, and a computer-readable storage medium. The present disclosure can coordinate member devices connected with a cross-domain device, thereby improving the flexibility of communication connections between member devices in multiple device domains and the cross-domain device.

### CROSS-REFERENCE TO RELATED APPLICATION

The present application claims the priority of China Patent Application No. 202111424081.4 filed on Nov. 26, 2021, and the disclosure of the above-mentioned China Patent Application is hereby incorporated in its entirety as a part of the present application.

### TECHNICAL FIELD

Embodiments of the present disclosure relate to a communication method, apparatus, electronic device, and computer-readable storage medium.

### BACKGROUND

With the development of smart home, there are more and more types of devices for smart home, forming different ecosystems. Devices in the same ecosystem form a device domain, and devices in the same device domain can be linked.

For example, a plurality of member devices of Company A form a device domain, and the plurality of member devices in the device domain can implement interconnection between the plurality of member devices.

### SUMMARY

At least one embodiment of the present disclosure provides a communication method applied to a cross-domain device, wherein the cross-domain device is configured to establish a communication connection with member devices in multiple device domains, and the multiple device domains include a first domain, the method comprising: acquiring a connection request; determining, according to the connection request, that a requester of the connection request is a member device in a first domain and determine a first domain threshold for the first domain; determining whether to establish a communication connection with the requester according to the connection request, in response to a number of direct communication connections established between member devices in the first domain and a cross-domain device reaching the first domain threshold.

For example, in the communication method provided by an embodiment of the present disclosure, determining whether to establish a communication connection with the requester according to the connection request, in response to the connection number of direct communication connections established between member devices in the first domain and a cross-domain device reaching the first domain threshold, comprises: judging whether the requester is a proxy device according to the connection request, in response to the number of direct communication connections established between member devices in the first domain and the cross-domain device reaching the first threshold; establishing a communication connection with the requester in response to the requester being the proxy device.

For example, in the communication method provided by an embodiment of the present disclosure, the first domain includes a first device, and the first device is directly communicatively connected with the cross-domain device, responding to the connection request in response to the requester being the proxy device comprises: disconnecting the direct communication connection between the first device and the cross-domain device in response to the requester being the proxy device; and establishing a direct communication connection between the proxy device and the cross-domain device; wherein the first device reconnects communicatively with the cross-domain device through any of proxy devices in the first domain.

For example, in the communication method provided by an embodiment of the present disclosure, the method further comprises: in response to the requester being not a proxy device, refusing to establish a direct communication connection with the requester, communicatively connecting by the requester with any proxy device in the first domain, and communicatively connecting with the cross-domain device through the proxy device.

For example, in the communication method provided by an embodiment of the present disclosure, the method further comprises: establishing a communication connection between the requester and a cross-domain device, in response to the number of direct communication connections in the first domain established with the cross-domain device not reaching the first domain threshold.

For example, in the communication method provided by an embodiment of the present disclosure, the cross-domain device establishes at most N direct communication connections, where N is an integer greater than 0, establishing a communication connection between the requester and a cross-domain device, in response to the number of direct communication connections in the first domain established with the cross-domain device not reaching the first domain threshold comprises: selecting a third device from a second domain, in response to the number of direct communication connections established with the cross-domain device reaching the N, and disconnecting the communication connection between the third device and the cross-domain device; and establishing a communication connection between the requester and the cross-domain device, wherein the third device is communicatively connected with a proxy device in the second domain, and the third device is communicatively connected with the cross-domain device through the proxy device in the second domain

For example, in the communication method provided by an embodiment of the present disclosure, the cross-domain device establishes at most N direct communication connections, where N is an integer greater than 0, determining, according to the connection request, that a requester of the connection request is a member device in a first domain and determine a first domain threshold for the first domain, comprises: determining, according to the connection request, that the requester of the connection request is a member device in the first domain and determining the first domain threshold for the first domain, in response to the number of direct communication connections established with the cross-domain device reaching the N.

For example, in the communication method provided by an embodiment of the present disclosure, the method further comprises: acquiring configuration parameters for allowing the multiple device domains to establish communication connection with the cross-domain device; broadcasting a record of domain name system service discovery in response to the configuration parameters, to allow at least one device domains to discover the cross-domain device; receiving an authentication request of the at least one device domain, and adding the at least one device domain to the cross-domain device, to allow a plurality of member devices in the at least one device domain to establish communication connection with the cross-domain device.

For example, in the communication method provided by an embodiment of the present disclosure, receiving an authentication request of the at least one device domain, and adding the at least one device domain to the cross-domain device, to allow a plurality of member devices in the at least one device domain to establish communication connection with the cross-domain device, comprises: receiving an authentication request of the at least one device domain, and establishing a connection with a management client in the at least one device domain based on the authentication request; acquiring configuration information from the management client in the at least one device domain, and configuring access rights for member devices in the at least one device domain to the cross-domain device according to the configuration information.

For example, in the communication method provided by an embodiment of the present disclosure, the configuration parameters include a time range and a domain-number of device domains establishing communication connections with the cross-domain device, and the domain-number of device domains are allowed to be added to the cross-domain device within the time range.

For example, in the communication method provided by an embodiment of the present disclosure, the connection request includes an identification of a device domain and an identification of the requester, determining, according to the connection request, that a requester of the connection request is a member device in a first domain and determine a first domain threshold for the first domain, comprises: determining the first domain to which the requester belongs and the first threshold for the first domain according to the identification of the device domain.

For example, in the communication method provided by an embodiment of the present disclosure, the connection request includes a type of the requester, judging whether the requester is a proxy device, in response to the number of direct communication connections in the first domain established with the cross-domain device reaching the first threshold, comprising: judging whether the requester is a proxy device according to the type of the requester, in response to the number of direct communication connections in the first domain established with the cross-domain device reaching the first threshold.

For example, in the communication method provided by an embodiment of the present disclosure, the cross-domain device receives data information from member devices in the multiple device domains; or the cross-domain device provides data information to member devices in the multiple device domains; wherein, in the case where the cross-domain device receives the data information from member devices in the multiple device domains, after the proxy device establishes a direct communication connection with the cross-domain device, the proxy device receives the data information from member devices communicatively connected with the proxy device, and provides the data information to the cross-domain device; in the case where the cross-domain device provides data information to member devices in the multiple device domains, after the proxy device establishes a direct communication connection with the cross-domain device, the proxy device is used to receive the data information from the cross-domain device and provide the data information to member devices communicatively connected with the proxy device.

For example, in the communication method provided by an embodiment of the present disclosure, the cross-domain device includes a sensor configured to sense a state of a target object, and the connection request includes a subscription request, the method further comprises: after the cross-domain device establishes a direct communication connection with the requester in response to the subscription request, sending data information to the requester to control the requester, in response to the sensor sensing a state change of the target object.

For example, in the communication method provided by an embodiment of the present disclosure, the cross-domain device includes a display device configured to display data information; the method further comprises: displaying data information from the requester in response to the cross-domain device establishing a direct communication connection with the requester.

At least one embodiment of the present disclosure provides a communication method applied to a cross-domain device, wherein the cross-domain device is configured to establish communication connections with member devices in multiple device domains at the same time, and the multiple device domains include a first domain, the method comprising: making a number of direct communication connections established with the cross-domain device less than or equal to a first domain threshold for the first domain.

For example, in the communication method provided by an embodiment of the present disclosure, making a number of direct communication connections established with the cross-domain device less than or equal to a first domain threshold for the first domain comprises: making the cross-domain device to be communicatively connected with at least two member devices in the first domain through the proxy device in the first domain.

For example, in the communication method provided by an embodiment of the present disclosure, making the cross-domain device to be communicatively connected with at least two member devices in the first domain through the proxy device in the first domain, in response to the number of direct communication connections in the first domain established with the cross-domain device reaching the first domain threshold for the first domain.

For example, in the communication method provided by an embodiment of the present disclosure, communicatively connecting with at least two member devices in the first domain through the proxy device in the first domain comprises: receiving a connection request, and determining whether to respond to the connection request according to a type of the requester initiating the connection request.

For example, in the communication method provided by an embodiment of the present disclosure, the at least two member devices include a first device, determining whether to respond to the connection request according to a type of the requester initiating the connection request comprises: establishing a direct communication connection with the proxy device in response to the requester being the proxy device, wherein the first device is communicatively connected with the proxy device; refusing to establish a communication connection with the requester in response to the requester not being the proxy device.

For example, in the communication method provided by an embodiment of the present disclosure, the at least two member devices further include a second device, responding to the connection request being communicatively connected with the proxy device, in response to the requester being the proxy device, comprises: disconnecting the direct communication connection between the second device and the cross-domain device; and establishing a direct communication connection with the proxy device.

For example, in the communication method provided by an embodiment of the present disclosure, communicatively connecting with at least two member devices in the first domain through the proxy device in the first domain further comprises: determining, after receiving the connection request, whether the number of direct communication connections in the first domain established with the cross-domain device reaches the first domain threshold; wherein responding to the connection request in response to the number of direct communication connections in the first domain established with the cross-domain device not reaching the first domain threshold.

At least one embodiment of the present disclosure provides a communication apparatus applied to a cross-domain device, wherein the cross-domain device is configured to establish communication connection with member devices in multiple device domains at the same time, and the multiple device domains include a first domain, the apparatus comprising: a request acquisition unit configured to acquire a connection request; a threshold determination unit configured to determine that a requester of the connection request is a member device in a first domain and determine a first domain threshold for the first domain according to the connection request; a response unit configured to determine whether to establish a communication connection with the requester according to the connection request, in response to a number of direct communication connections established between member devices in the first domain and the cross-domain device reaching the first domain threshold.

At least one embodiment of the present disclosure provides a communication apparatus applied to a cross-domain device, wherein the cross-domain device is configured to establish communication connection with member devices in multiple device domains at the same time, and the multiple device domains including a first domain, the apparatus comprising: a control unit configured to make a number of direct communication connections established with the cross-domain device less than or equal to a first domain threshold for the first domain.

At least one embodiment of the present disclosure provides an electronic device comprising: a processor; and a memory including one or more computer program instructions, wherein the one or more computer program instructions are stored in the memory and, when executed by the processor, implement the instructions of the communication method provided by any embodiment of the present disclosure.

At least one embodiment of the present disclosure provides a computer-readable storage medium having non-temporarily stored computer-readable instructions therein, wherein the computer-readable instructions, when executed by a processor, can implement the communication method provided by any embodiment of the present disclosure.

### BRIEF DESCRIPTION OF DRAWINGS

In order to illustrate the technical scheme of the embodiments of the present disclosure more clearly, the accompanying drawings of the embodiments will be briefly introduced below. Obviously, the accompanying drawings in the following description merely relate to some embodiments of the present disclosure, and are not limited to the present disclosure.

FIG. 1A shows a scenario in which a cross-domain device is applied;

FIG. 1B shows another scenario in which a cross-domain device is applied;

FIG. 2 shows a flowchart of a communication method provided by at least one embodiment of the present disclosure;

FIG. 3A shows a schematic diagram of a communication connection established by utilizing the communication method provided by at least one embodiment of the present disclosure;

FIG. 3B shows a schematic diagram of another communication connection established by utilizing the communication method provided by at least one embodiment of the present disclosure;

FIG. 4 shows a flowchart of a communication method provided by at least one embodiment of the present disclosure;

FIG. 5 shows a flowchart of another communication method provided by at least one embodiment of the present disclosure;

FIG. 6A shows a flowchart of a communication method provided by at least one embodiment of the present disclosure;

FIGS. 6B˜6D are schematic diagrams showing the communication method shown in FIG. 6A;

FIG. 7A shows a flowchart of a communication method provided by at least one embodiment of the present disclosure;

FIGS. 7B and 7C are schematic diagrams showing the communication method shown in FIG. 7A;

FIG. 8A shows a flowchart of a communication method provided by at least one embodiment of the present disclosure;

FIG. 8B is a schematic diagram showing the communication method shown in FIG. 8A;

FIG. 9 shows a schematic block diagram of a communication apparatus provided by at least one embodiment of the present disclosure;

FIG. 10 shows a schematic block diagram of another communication apparatus provided by at least one embodiment of the present disclosure;

FIG. 11 shows a schematic block diagram of an electronic device provided by at least one embodiment of the present disclosure;

FIG. 12 shows a schematic block diagram of another electronic device provided by at least one embodiment of the present disclosure; and

FIG. 13 shows a schematic diagram of a computer-readable storage medium provided by at least one embodiment of the present disclosure.

### DETAILED DESCRIPTION

In order to make the purpose, technical scheme and advantages of the embodiments of the present disclosure clearer, the technical scheme of the embodiments of the present disclosure will be described clearly and completely in conjunction with the accompanying drawings. Obviously, the described embodiments are part of the embodiments of the present disclosure, not all the embodiments. Based on the described embodiments of the present disclosure, all other embodiments obtained by ordinary skilled in the art without creative labor belong to the protection scope of the present disclosure.

Unless otherwise defined, the technical or scientific terminologies used in the present disclosure should have common meanings as understood by ordinary skilled ones in the art to which the present disclosure belongs. The terms “first”, “second” and the like used in the present disclosure do not indicate any order, quantity or importance, but are only used to distinguish different components. Similarly, words such as “a”, “an”, “the” or the like do not indicate a quantity limit, but indicate an existence of at least one. A word such as “including”, “containing” or the like mean that an element or object appearing before the word encompasses the elements or objects listed after the word and their equivalents, without excluding other elements or objects. A word such as “connected”, “interconnected” or the like are not limited to physical or mechanical connections, but may include electrical connections, whether direct or indirect. “Up”, “Down”, “Left” and “Right” are only used to indicate a relative positional relationship. When the absolute position of the described object changes, the relative positional relationship may change accordingly.

The member devices in the same device domain may be linked with other devices in the device domain, and intelligent control can be implemented by means of the linkage. Taking a member device as an example, other devices (e.g., lamps, air purifiers, water heaters, humidifiers, etc.) obtain the state of the door lock by interacting with the door lock, so as to carry out the intelligent control. For example, when the door lock is in an open state, other devices carry out a control related to “going back home mode”. For example, the lamp is turned on, the air purifier is turned on, the water heater is turned on, and the humidifier is turned on. For another example, when the door lock is in a closed state, other devices carry out an intelligent control related to “leaving home mode”. For example, the TV is turned off, the lamp is turned off, the air purifier is turned off, the sweeping robot is turned on, and the camera is turned on, and so on.

In order to enable the member devices in device domain A to communicate with the member devices in device domain B, device domain A may allow its own member device A1 to join device domain B, so that the member device A1 becomes a cross-domain device.

After a member device joins a different device domain to become a cross-domain device, the cross-domain device may interact with member devices in different device domains, and member devices in different device domains may request data from or send data to the cross-domain device. However, due to the limited resources of the cross-domain device (including power, memory, processing capacity, or network bandwidth) and the like, the cross-domain device can only fulfill a limited number of communication connections.

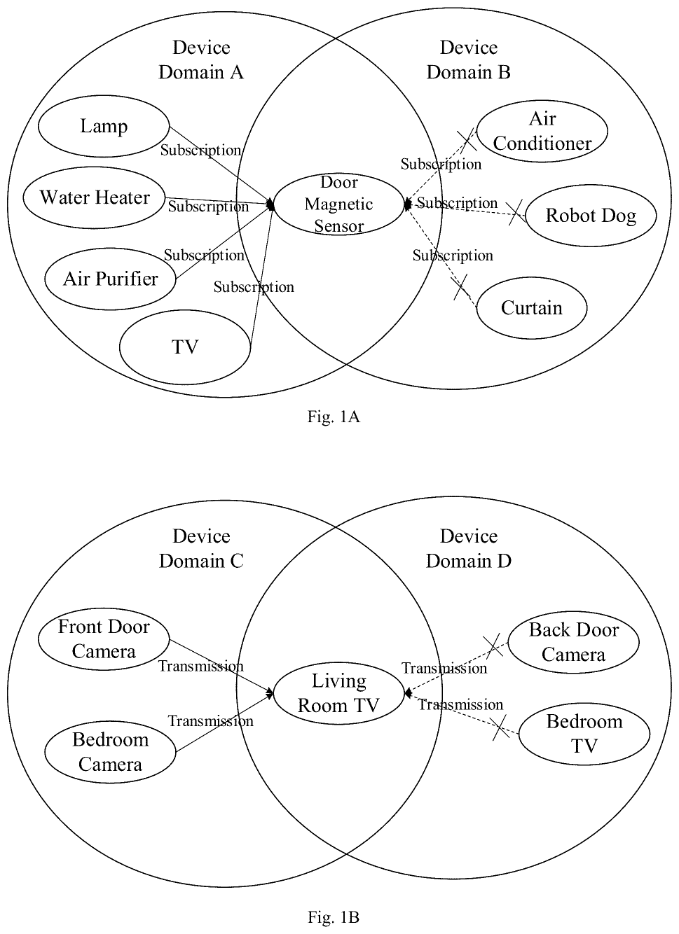

FIG. 1A shows a scenario in which a cross-domain device is applied.

As shown in FIG. 1A, in this scenario, a door magnetic sensor is a cross-domain device in both device domain A and device domain B. Device domain A includes a lamp, a water heater, an air purifier, and a television (TV). Device domain B includes an air conditioner, a robot dog, and a curtain.

For example, the four devices in device domain A (namely, lamp, water heater, air purifier, and TV) receive data sent by the door magnetic sensor by initiating a subscription request to the door magnetic sensor. Due to the limited processing capacity of the door magnetic sensor, it can only receive a limited number of subscription requests (e.g., the door magnetic sensor can only accept four subscription requests). When the air conditioner, the robot dog, and the curtain in device domain B initiate a subscription request to the door magnetic sensor, the subscription requests sent by three devices in device domain B will all fail because the door magnetic sensor is unable to receive a new subscription request, thereby leading to the devices in device domain B being unable to acquire data of the door magnetic sensor, and thus unable to implement intelligent device control of door opening/closing, affecting user's experience.

FIG. 1B shows another scenario in which a cross-domain device is applied.

As shown in FIG. 1B, in this scenario, a living room TV is a cross-domain device in both device domain C and device domain D. Device domain C includes a front door camera and a bedroom camera. Device domain D includes a back door camera and a bedroom TV.

For example, the living room TV supports displaying 2 content sources at the same time. The manager of device domain C has set that the front door camera picture is automatically transmitted onto the living room TV in response to the front door doorbell being triggered, and when the bedroom camera detects a crying sound, it automatically transmits the picture acquired by the bedroom camera to the living room TV; and the manager of device domain D has set that when the back door doorbell is triggered, the back door camera picture is automatically transmitted onto the living room TV, and when the bedroom TV detects an abnormal sound, it automatically establishes a connection with the living room TV. When the front door camera in device domain C detects that the front door doorbell is triggered while the bedroom camera detects a crying sound, they send their respective contents to the living room TV, and at this time, the living room TV displays the contents of the front door camera and the bedroom camera. If the back door camera in device domain D detects that the back door doorbell is triggered when the pictures transmitted by the front door camera and bedroom camera are displayed on the living room TV, the communication connection requested by the back door camera to be established with the living room TV will be rejected, because the living room TV can only display 2 content sources at the same time.

Therefore, when there are multiple device domains, it is difficult to coordinate the connections between member devices in different device domains and the cross-domain device. This difficulty may lead to the rejection of certain communication connections, ultimately affecting the user's experience.

At least one embodiment of the present disclosure provides a communication method, a communication apparatus, an electronic device, and a computer-readable storage medium. The communication method is applied to a cross-domain device, wherein the cross-domain device is configured to establish a communication connection with member devices in multiple device domains at the same time, and the multiple device domains include a first domain. The communication method comprises: acquiring a connection request; determining, according to the connection request, that a requester of the connection request is a member device in a first domain and determining a first domain threshold for the first domain; determining whether to establish a communication connection with the requester according to the connection request, in response to a number of direct communication connections established between member devices in the first domain and a cross-domain device reaching the first domain threshold. The method facilitates the coordination of member devices connected to the cross-domain device, thereby enhancing the flexibility of communication connections among member devices in multiple device domains and the cross-domain device. This alleviates the issue where, in instances where direct communication connections between some member devices in the device domain and the cross-domain device reach the first domain threshold, other member devices in the same domain cannot establish communication connections with the cross-domain device.

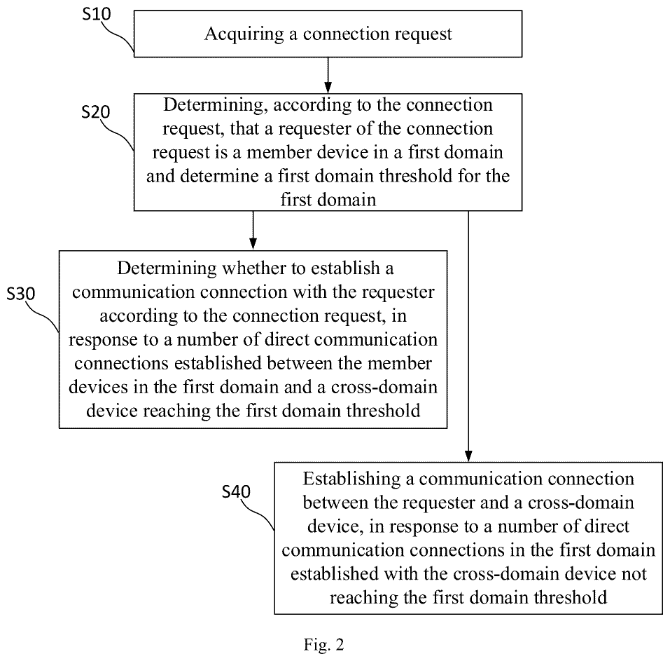

FIG. 2 shows a flowchart of a communication method provided by at least one embodiment of the present disclosure.

As shown in FIG. 2, the method may include steps S10 to S30. The method is applied to a cross-domain device, wherein the cross-domain device is configured to establish communication connections with member devices in multiple device domains at the same time, and the multiple device domains include a first domain.

Step S10: Acquiring a connection request.

Step S20: Determining, according to the connection request, that a requester of the connection request is a member device in a first domain and determine a first domain threshold for the first domain.

Step S30: Determining whether to establish a communication connection with the requester according to the connection request, in response to a number of direct communication connections established between member devices in the first domain and a cross-domain device reaching the first domain threshold.

In some embodiments of the present disclosure, the cross-domain device may be a sensor, such as a door magnetic sensor. The door magnetic sensor is, for example, installed on the door to sense the state of the door.

In some embodiments of the present disclosure, the cross-domain device may be a display device with a display screen, such as a TV. The display device is used to display data information, which may be image data, for example.

For step S10, the connection request may be issued by any member device in multiple device domains to the cross-domain device.

In some embodiments of the present disclosure, the connection request may be a subscription request for a member device to request to acquire data information from a cross-domain device. In these embodiments, the cross-domain device is configured to provide data information to a member device. For example, in the scenario shown in FIG. 1A, a member device in device domain A (e.g., one or more of lamp, water heater, air purifier, and TV) may send a subscription request to the door magnetic sensor. If the door magnetic sensors establish a communication connection with the member device in response to the subscription request, then the door magnetic sensors send data information to the member device in response to the state change of the door lock.

In other embodiments of the present disclosure, the connection request may be a request for a member device to provide data information to a cross-domain device. In these embodiments, the cross-domain device is configured to receive data information from a member device. For example, in the scenario shown in FIG. 1B, the cross-domain device is a living room TV, which receives pictures from the front door camera, pictures acquired by the bedroom camera, etc.

For example, in the scenario shown in FIG. 1A,in step S10, the cross-domain device, specifically the door magnetic sensor, receives a connection request from an air conditioner in device domain B.

For another example, in the scenario shown in FIG. 1B, step S10 may involve the cross-domain device, specifically the living room TV, receiving a connection request from the back door camera in device domain D.

In some embodiments of the present disclosure, the connection request includes an identification of the device domain and an identification of the requester. For example, the connection request includes name or number of the device domain and name or number of the requester. The requester may be any member device in the device domain.

For step S20, for example, according to the identification of the device domain, the first domain to which the requester belongs and the first threshold for the first domain are determined.

In some embodiments of the present disclosure, the cross-domain device may, according to its own configuration and its own ability to respond to connection requests, allocate thresholds to the respective device domain. For example, if the configuration of the cross-domain device is to equally allocate, and the cross-domain device responds to at most N direct communication connections, where N is an integer greater than 0, then these N direct communication connections are evenly distributed among the device domains based on the number of domains that the cross-domain device is permitted to access. This ensures that the thresholds for each device domain are uniform.

The configuration of the cross-domain device can be set either by a skilled professional before the device leaves the factory or by a manager responsible for the cross-domain device. The present disclosure does not limit the configuration of the cross-domain device, and the skilled in the art or the manager may configure the cross-domain device according to their own needs.

In some embodiments of the present disclosure, the device domain to which the requester belongs is determined according to the domain name or domain ID of the device domain carried in the connection request. For example, the requester is a member device in the first domain.

In some embodiments of the present disclosure, the device domain to which the requester belongs is determined according to the device identification carried in the connection request. The device identification consists of a domain name or domain ID and a device ID. For example, the requester is a member device in the first domain, and the device identification is domain ID+device ID.

In some embodiments of the present disclosure, the cross-domain device establishes at most N direct communication connections, where N is an integer greater than 0. Step S20 includes: determining, according to the connection request, that the requester of the connection request is a member device in the first domain and determining the first domain threshold for the first domain, in response to the number of direct communication connections established with the cross-domain device reaching N.

In the embodiment of the present disclosure, if the cross-domain device is, through one member device, communicatively connected with another member device, then the cross-domain device is directly connected with the one member device and indirectly connected with another member device.

In this embodiment, when the number of direct communication connections established with the cross-domain device reaches the maximum value (i.e., N) for the cross-domain device, the device domain to which the requester belongs and the threshold for the device domain to which the requester belongs are determined according to the connection request. When the number of direct communication connections established with the cross-domain device does not reach the maximum value (i.e., N) for the cross-domain device, the cross-domain device may directly establish a direct communication connection with the requester.

Since the cross-domain device may directly establish a direct communication connection with the requester when the number of direct communication connections established with the cross-domain device does not reach the maximum value for the cross-domain device, this embodiment can improve the responding speed of the cross-domain device and make full use of the ability of the cross-domain device to receive data information and send subscription messages.

For step S30, for example, in response to the connection number of direct communication connections established between member devices in the first domain and the cross-domain device reaching the first threshold, it is judged whether the requester is a proxy device according to the connection request.

In some embodiments of the present disclosure, for example, in response to the requester being a proxy device, a direct communication connection is established with the requester. In response to the requester being not a proxy device, a direct communication connection is refused to be established with the requester, and the requester is communicatively connected with any proxy device in the first domain and communicatively connected with the cross-domain device through the proxy device. That is, in some embodiments of the present disclosure, the member devices in the same domain have different priorities, wherein the priority of a proxy device is higher than that of a non-proxy device. If the requester is a proxy device with a higher priority, the cross-domain device establishes a communication connection with the requester; or if the requester is a member device with a lower priority, the cross-domain device refuses to establish a communication connection with the requester.

If the requester is not a proxy device, a communication connection is refused to be established with the requester, and the requester searches for a proxy device in the first domain, so as to communicatively connect with the searched proxy device, and communicatively connect with the cross-domain device through the proxy device.

In the embodiment of the present disclosure, the proxy device may be any member device in the first domain installed with a proxy program or transmission program. The proxy program is used to forward connection requests from other member devices in the device domain that establish communication connection with the proxy device to the cross-domain device, and to forward subscription messages or data information from the cross-domain device to other member devices in the device domain that establish communication connection with the proxy device. The transmission program is used to provide the cross-domain device with data information from member devices in the device domain.

For example, in the scenario shown in FIG. 1A, if the TV is installed with a proxy program, the TV may act as a proxy device, and if the water heater is also installed with a proxy program, the water heater may also be a proxy device. For another example, in the scenario shown in FIG. 1B, if the back door camera is installed with a transmission program, the back door camera may act as a proxy device.

In the embodiment of the present disclosure, the connection request includes the type of the requester. Judging whether the requester is a proxy device according to the connection request, in response to the number of direct communication connections established with the cross-domain device in the first domain reaching a first domain threshold, comprises: judging whether the requester is a proxy device according to the type of the requester carried in the connection request, in response to the number of direct communication connections established with the cross-domain device in the first domain reaching the first domain threshold.

The type of the requester may indicate whether the member device issuing the connection request is a proxy device. For example, in the ecosystem of Company A, considering the TV as the proxy device, then if the type of requester carried in the connection request is a TV, the requester is the proxy device, or if the type of requester carried in the connection request is a humidifier, the requester is not the proxy device.

In some embodiments of the present disclosure, the first domain includes a first device. The first device is directly communicatively connected with the cross-domain device. Responding to the connection request in response to the requester being the proxy device comprises: disconnecting the direct communication connection between the first device and the cross-domain device in response to the requester being the proxy device; and establishing a direct communication connection between the proxy device and the cross-domain device. The first device reconnects communicatively with the cross-domain device through any of proxy devices in the first domain.

In these embodiments, the first device is a non-proxy device in the first domain that is directly communicatively connected with the cross-domain device. In these embodiments, the direct communication connection between the non-proxy device and the cross-domain device is disconnected, so that the requester establishes a communication connection with the cross-domain device, and the first device establishes an indirect communication connection with the cross-domain device through the proxy device. That is, in these embodiments, in response to the number of direct communication connections established between the member devices in the first domain and the cross-domain device reaching the first domain threshold, and if the requester of the connection request is a proxy device, the direct communication connection between the non-proxy devices with a lower priority in the first domain and the cross-domain device is disconnected, so that the cross-domain device establishes a communication connection with the proxy device with a higher priority.

As shown in FIG. 2, in addition to steps S10˜S30, the communication method includes step S40.

Step S40: Establishing a communication connection between the requester and a cross-domain device, in response to a number of direct communication connections in the first domain established with the cross-domain device not reaching the first domain threshold.

For example, the first domain threshold is 10. If the number of direct communication connections in the first domain established with the cross-domain device is 7 when the connection request is received, the cross-domain device establishes a communication connection with the requester, so as to send a subscription message to the requester or receive data information from the requester.

In some embodiments of the present disclosure, the cross-domain device establishes at most N direct communication connections, where N is an integer greater than 0. Step S40 includes: selecting a third device from a second domain, in response to the number of direct communication connections established with the cross-domain device reaching N, disconnecting the communication connection between the third device and the cross-domain device; and establishing a communication connection between the requester and the cross-domain device. The third device is communicatively connected with the proxy device in the second domain, and the third device is communicatively connected with the cross-domain device through the proxy device in the second domain.

In these embodiments, if the number of direct communication connections in the first domain established with the cross-domain device does not reach the first domain threshold, instead, the number of direct communication connections established with the cross-domain device reaches the maximum, the third device is selected from the second domain, the communication connection between the third device and the cross-domain device is disconnected, and the communication connection between the requester and the cross-domain device is established.

For example, the third device may be a non-proxy device with a lower priority in the second domain.

For example, in the scenario shown in FIG. 1A, if the cross-domain device receives a connection request from an air conditioner in device domain B, at this time the number of connections of device domain B does not reach the threshold for device domain B, and the number of direct communication connections established with the cross-domain device reaches the maximum value N, the cross-domain device may disconnect the direct communication connection with a member device (e.g., lamp) in device domain A, so as to establish a direct communication connection with the air conditioner in device domain B.

In some embodiments of the present disclosure, the cross-domain device provides data information to member devices in multiple device domains. In the case where the cross-domain device provides data information to member devices in multiple device domains, after the proxy device establishes a direct communication connection with the cross-domain device, the proxy device is configured to receive data information from the cross-domain device and provide the data information to member devices communicatively connected with the proxy device.

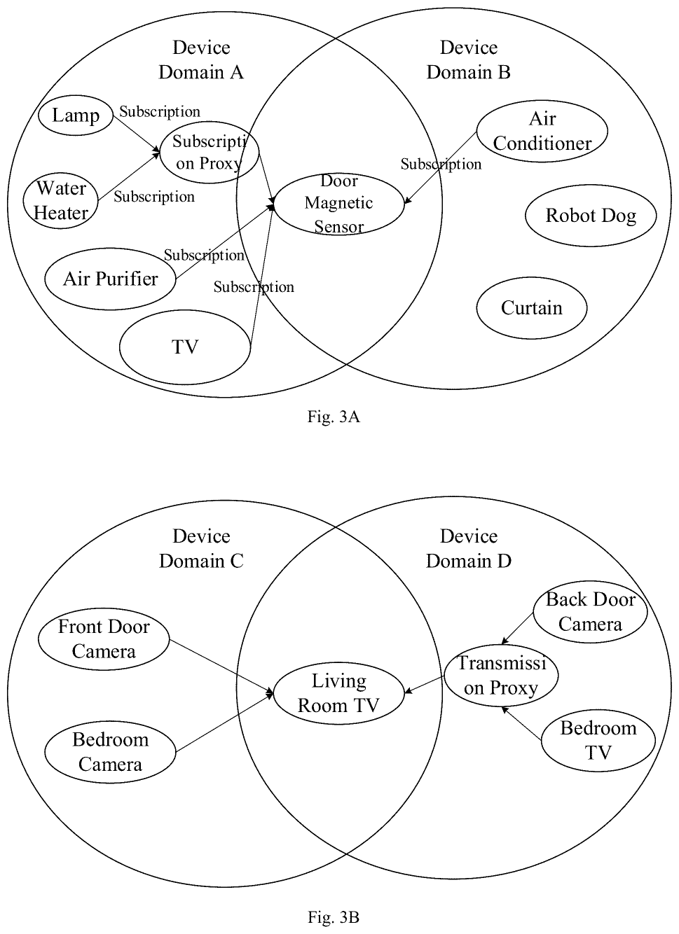

FIG. 3A shows a schematic diagram of a communication connection established by utilizing the communication method provided by at least one embodiment of the present disclosure.

The example of FIG. 3A is that a cross-domain device provides data information to a member device.

As shown in FIG. 3A, in this embodiment, the device domain includes device domain A and device domain B, and the cross-domain device is a door magnetic sensor. Device domain A includes a subscription proxy, which may be a proxy program and may be set in any member device. The member device in which the subscription proxy is set is a proxy device. In the scenario shown in FIG. 3A, the subscription proxy is set in other member devices different from the lamp, water heater, air purifier and TV in device domain A. For example, the subscription proxy is set in the stereo.

As shown in FIG. 3A, after the subscription proxy establishes a direct communication connection with the cross-domain device, the lamp and water heater in device domain A are communicatively connected with the door magnetic sensor through the subscription proxy, and the air purifier and TV are directly communicatively connected with the door magnetic sensor, respectively. The air conditioner in device domain B is directly communicatively connected to the door magnetic sensor. The robot dog and curtain in device domain B have not established a communication connection with the door magnetic sensor.

In the scenario shown in FIG. 3A, device domain A reduces, through a subscription proxy, the number of direct communication connections established between member devices in device domain A and the cross-domain device. That is, within a single device domain, sending subscription requests directly to the cross-domain device is reduced by subscription proxy.

In some embodiments of the present disclosure, the cross-domain device includes a sensor configured to sense the state of a target object. The connection request includes a subscription request. The communication method further comprises: after establishing a direct communication connection with the requester in response to the subscription request, the cross-domain device sends data information to the requester to control the requester, in response to the sensor sensing a state change of the target object.

As shown in FIG. 3A, the cross-domain device is a door magnetic sensor configured to sense the state of the door. After establishing a direct communication connection with the air purifier, the TV, and the subscription proxy (e.g., the stereo) respectively in response to the subscription requests of the air purifier, the TV and the stereo, the door magnetic determines to execute a “leaving home” mode in response to the sensor sensing a state change of the door, and sends data information to the air purifier, the TV and the stereo to control the air purifier, the TV and the stereo to turn off.

In some embodiments of the present disclosure, the cross-domain device receives data information from member devices in multiple device domains. In the case where the cross-domain device receives data information from member devices in multiple device domains, after the proxy device establishes a direct communication connection with the cross-domain device, the proxy device is configured to receive data information from member devices communicatively connected with the proxy device, and send data information to the cross-domain device.

FIG. 3B shows a schematic diagram of another communication connection established by utilizing the communication method provided by at least one embodiment of the present disclosure.

The example of FIG. 3B is that a cross-domain device receives data information from member devices in multiple device domains.

As shown in FIG. 3B, in this embodiment, the device domain includes device domain C and device domain D, and the cross-domain device is a living room TV. Device domain D includes a transmission proxy, which may be a proxy program, and may be set in any member device in device domain D. The member device in which the transmission proxy is set is a proxy device. In the scenario shown in FIG. 3B, the transmission proxy is set in other member devices different from the back door camera and the bedroom camera in device domain D. For example, the transmission proxy is set in the kitchen camera.

As shown in FIG. 3B, after the transmission proxy establishes a direct communication connection with the cross-domain device, the back door camera and bedroom camera in device domain D are communicatively connected with the living room TV through the transmission proxy. The front door camera and bedroom camera in device domain C are directly communicatively connected with the living room TV, respectively.

In the scenario shown in FIG. 3B, device domain D reduces, through a transmission proxy, the number of direct communication connections established between member devices in device domain D and the cross-domain device.

In the scenario of FIG. 3B, the transmission proxy may provide the cross-domain device with the data information of member devices connected with the transmission proxy according to preset rules. For example, the transmission proxy alternately and circularly provides the cross-domain device with the data information from the back door camera and bedroom TV.

In some embodiments of the present disclosure, the cross-domain device includes a display device configured to display data information. The communication method further comprises: displaying data information from the requester in response to the cross-domain device establishing a direct communication connection with the requester.

As shown in FIG. 3B, the cross-domain device is a living room TV configured to display data information. For example, in response to establishing a direct communication connection with the front door camera and the bedroom camera, the living room TV displays the image data from the front door camera and the bedroom camera.

The communication method described above will be further elaborated in combination with some embodiments to facilitate understanding of the communication method provided by the present disclosure.

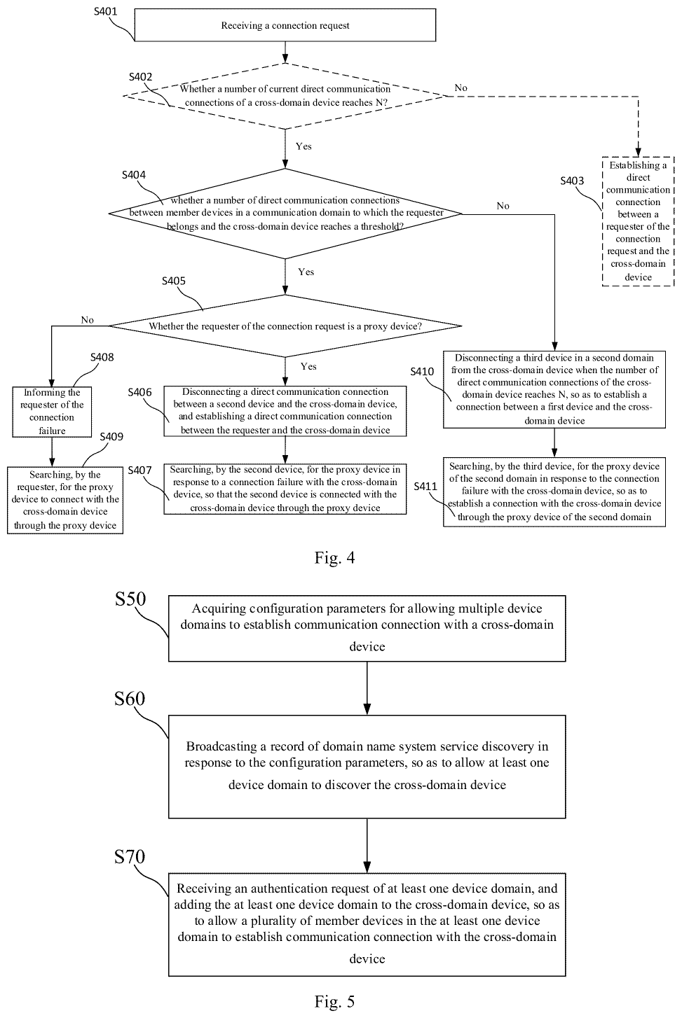

FIG. 4 shows a flowchart of a communication method provided by at least one embodiment of the present disclosure.

As shown in FIG. 4, the communication method may include steps S401˜S411.

Step S401: Receiving a connection request.

The connection request may be any member device in any device domain. Step S401 is similar to step S10 in FIG. 2 above, and will not be detailed here.

Step S402: Determining whether a number of current direct communication connections of a cross-domain device reaches N, where N is a maximum number of direct communication connections that can be established with the cross-domain device, and N is an integer greater than 0. If the number of current direct communication connections of the cross-domain device does not reach N, step S403 is executed. If the number of current direct communication connections of the cross-domain device reaches N, step S404 is executed.

Step S403: Establishing a direct communication connection between a requester of the connection request and the cross-domain device.

In other embodiments of the present disclosure, step S402 may not be executed, instead, step S404 may be directly executed.

Step S404: Determining whether a number of direct communication connections between member devices of a communication domain to which the requester belongs and the cross-domain device reaches a threshold.

If the number of direct communication connections between the member devices of the communication domain to which the requester belongs and the cross-domain device reaches the threshold, step S405 is executed. If the number of direct communication connections between the member devices of the communication domain to which the requester belongs and the cross-domain device does not reach the threshold, step S406 is executed.

For example, the requester is a member device belonging to the first domain, and judges whether the number of direct communication connections between the member devices in the first domain and the cross-domain device reaches the first domain threshold. If the number of direct communication connections between the member devices in the first domain and the cross-domain device reaches the first domain threshold, step S405 is executed.

If the number of direct communication connections between the member devices in the first domain and the cross-domain device does not reach the first domain threshold, and the number of direct communication connections of the cross-domain device reaches N, step S410 is executed.

In other embodiments that do not include step S402, if the number of direct communication connections between the member devices in the first domain and the cross-domain device does not reach the first domain threshold, before executing step S410, it is possible to execute a step of judging whether the number of current direct communication connections of the cross-domain device reaches N.

If the number of direct communication connections between the member devices in the first domain and the cross-domain device does not reach the first domain threshold, and the number of direct communication connections of the cross-domain device does not reach N, a direct communication connection between the requester and the cross-domain device is established.

Step S405: Judging whether the requester of the connection request is a proxy device. If the requester is a proxy device, step S406 is executed. If the requester is not a proxy device, step S408 is executed.

Step S406: Disconnecting a direct communication connection between a second device and the cross-domain device, and establishing a direct communication connection between the requester and the cross-domain device. The second device is a member device in the device domain to which the requester belongs. For example, the second device may be a non-proxy device in the device domain to which the requester belongs.

Step S407: Searching, by the second device, for the proxy device in response to a connection failure with the cross-domain device, so that the second device is connected with the cross-domain device through the proxy device.

Step S408: Informing the requester of the connection failure. For example, the cross-domain device may send a message of connection failure to the requester.

Step S409: Searching, by the requester, for the proxy device to connect with the cross-domain device through the proxy device.

Step S410: Disconnecting a third device in a second domain from the cross-domain device when the number of direct communication connections of the cross-domain device reaches N, so as to establish a connection between a first device and the cross-domain device.

For example, in the scenario shown in FIG. 1A, if the cross-domain device receives a connection request from an air conditioner in device domain B, and the number of connections of device domain B does not reach the threshold for device domain B at this time, and the number of direct communication connections established with the cross-domain device reaches the maximum value N, the cross-domain device may disconnect a direct communication connection with one member device (e.g., a lamp) in device domain A to establish a direct communication connection with the air conditioner in device domain B.

Step S411: Searching, by the third device, for the proxy device of the second domain in response to the connection failure with the cross-domain device, so as to establish a connection with the cross-domain device through the proxy device of the second domain.

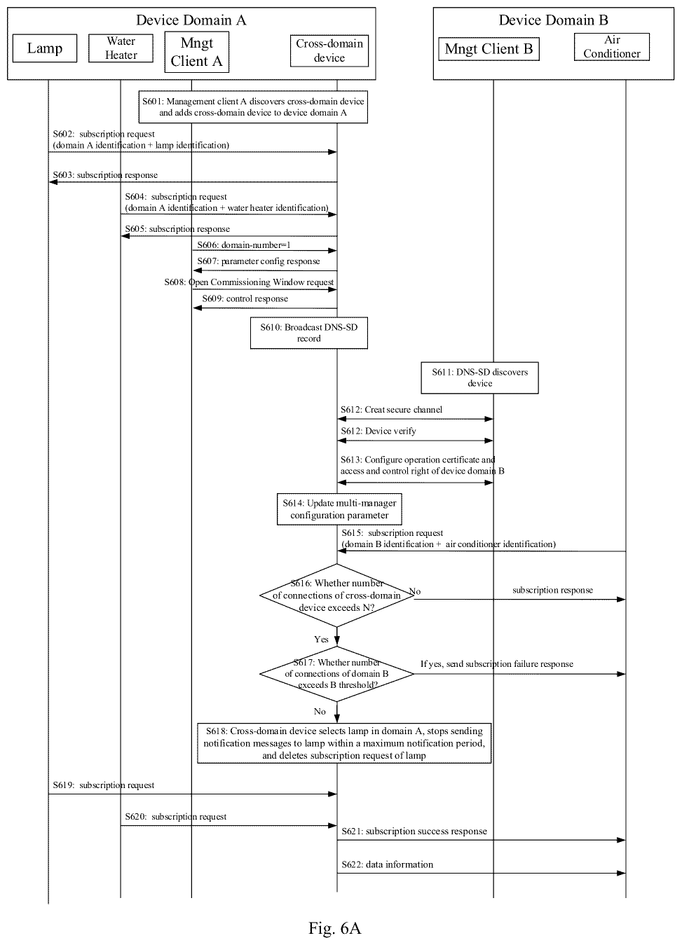

FIG. 5 shows a flowchart of another communication method provided by at least one embodiment of the present disclosure.

As shown in FIG. 5, in addition to steps S10˜S40 shown in FIG. 2, the method includes steps S50˜S70.

Step S50: Acquiring configuration parameters for allowing multiple device domains to establish communication connection with a cross-domain device.

Step S60: Broadcasting a record of domain name system service discovery in response to the configuration parameters, so as to allow at least one device domain to discover the cross-domain device.

Step S70: Receiving an authentication request of at least one device domain, and adding the at least one device domain to the cross-domain device, so as to allow a plurality of member devices in the at least one device domain to establish communication connection with the cross-domain device.

For step S50, for example, the cross-domain device belongs to device domain A, and a management client A for managing device domain A may send configuration parameters to the cross-domain device. For example, in the scenario shown in FIG. 1A, the cross-domain device is a door magnetic sensor. In an embodiment of the present disclosure, the management client may be an application program installed on a terminal device. The terminal device may be, for example, a mobile phone, a tablet, a computer, etc.

For example, users may send configuration parameters to the cross-domain device by operating on the management client installed on the mobile phone. In some embodiments of the present disclosure, the configuration parameters include a domain-number of device domains establishing communication connections with the cross-domain device. This allows the domain-number of device domains to be added to the cross-domain device.

For example, the domain-number may indicate a number of newly added device domains that are allowed to access the cross-domain device. For example, if the domain-number is 1, it is allowed to add one new device domain to manage and access the cross-domain device.

In other embodiments of the present disclosure, in addition to the domain-number, the configuration parameters may include a time range. Within the time range, a domain-number of device domains are allowed to be added to the cross-domain device, which can improve the security of the cross-domain device. For example, the time range is from a moment at which the configuration parameters are received to 10 minutes after the configuration parameters are received, allowing the domain-number of device domains to be added to the cross-domain device.

For step S60, for example, after receiving the configuration parameters, the cross-domain device broadcasts a record of Domain Name System Server Discovery (DNS-SD), so as to allow at least one device domain to discover the cross-domain device.

For example, the management client corresponding to the device domain that needs to establish a communication connection with the cross-domain device may discover the cross-domain device through DNS-SD. The management client corresponding to the device domain is configured to manage the device domain.

For example, device domain B discovers through DNS-SD that the cross-domain device is a door magnetic sensor.

For step S70, the authentication request may be an identity authentication request sent by the management client corresponding to the device domain to the cross-domain device. For example, the management client corresponding to the device domain may establish a PASE secure connection with the cross-domain device by means of password authentication. Of course, those skilled in the art may also employ other authentication methods to make the client corresponding to the device domain that needs to establish a communication connection with the cross-domain device establish a secure connection with the cross-domain device.

In some embodiments of the present disclosure, step S70 includes: receiving an authentication request of at least one device domain, and establishing a connection with a management client in the at least one device domain based on the authentication request; and acquiring configuration information from the management client in the at least one device domain, and configuring access rights for member devices in the at least one device domain to the cross-domain device according to the configuration information.

In some embodiments of the present disclosure, the configuration information may include, for example, an operation certificate and an access and control right for another device domain that needs to establish a communication connection with the cross-domain device etc.

For example, after a management client of device domain B establishes a PASE secure connection with the door magnetic sensor by means of password authentication, the management client of device domain B sends the operation certificate and the access and control right (e.g., an access and control list) for device domain B etc., to the door magnetic sensor. In response to receiving the configuration information, the cross-domain device adds the door magnetic sensor to device domain B, so that member devices in device domain B can establish communication connection with the door magnetic sensor.

A single device domain has the same device operation certificate or node operation certificate, and communication messages between devices in a single device domain are encrypted by the device operation certificate or node operation certificate to ensure the security of information. Different device domains have different device operation certificates or node operation certificates, so communication cannot be made between devices in different device domains because the devices in different device domains cannot employ a unified device operation certificate or node operation certificate to perform encrypting and decrypting operations on communication messages. The cross-domain device have a plurality of device operation certificates or node operation certificates, so the cross-domain device can interact with devices in multiple domains at the same time.

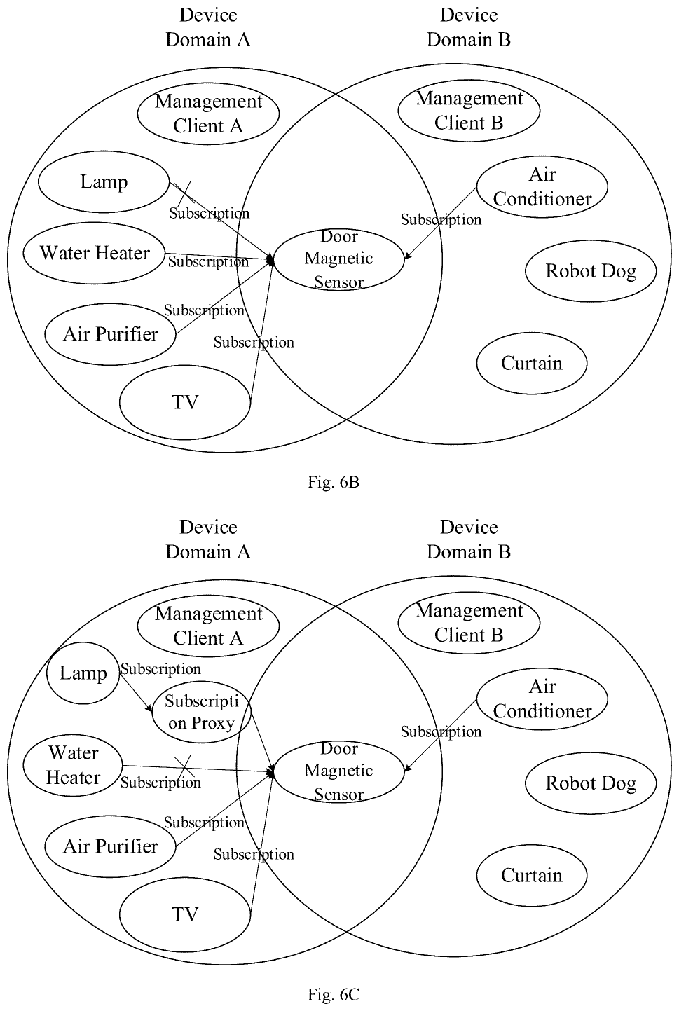

FIG. 6A shows a flowchart of a communication method provided by at least one embodiment of the present disclosure.

FIGS. 6B to 6D are schematic diagrams showing the communication method shown in FIG. 6A.

As shown in FIG. 6A, the communication method may include steps S601-S618.

Step S601: A management client A discovers a cross-domain device (e.g., door magnetic sensor) and adds the cross-domain device to device domain A. At this time, device domain A includes a lamp, a water heater, a manager client, and the cross-domain device.

Step S602: The lamp in device domain A sends to the cross-domain device a subscription request including an identification of device domain A and an identification of the lamp.

Step S603: The cross-domain device sends a subscription response to the lamp. For example, after receiving the subscription request of the lamp, the door magnetic sensor, in response to the state change of the door lock being closed, sends data information to the lamp indicating the lamp to turn off. The data information indicating the lamp to turn off is the subscription response.

Step S604: The water heater in device domain A sends to the cross-domain device a subscription request including the identification of device domain A and an identification of the water heater.

Step S605: The cross-domain device sends a subscription response to the water heater.

Step S606: The management client A sends a domain-number to the cross-domain device, and allows the domain-number of device domains to be added to the cross-domain device. For example, the domain-number is equal to 1. The cross-domain device updates multi-manager configuration parameter in response to the domain-number.

Step S607: The management client A receives a parameter configuration response returned by the cross-domain device. The parameter configuration response, for example, notifies the management client that the configuration of the domain-number is successful or failed.

Step S608: The management client A sends to a sensing device an Open Commissioning Window request including a time range, so as to allow the domain-number of device domains to be added to the cross-domain device within the time range.

Step S609: The management client A receives a control response sent by the cross-domain device, wherein the control response is used to indicate whether the cross-domain device is successfully triggered to start opening commissioning, and when returning a success, the next step S610 is executed.

Step S610: The cross-domain device broadcasts a DNS-SD record.

Step S611: A management client B discovers the cross-domain device through DNS-SD. The management client B is a client for managing device domain B.

Step S612: The management client B establishes a secure connection channel with the cross-domain device and verifies the device. For example, management client B establishes a PASE secure connection channel with the cross-domain device by means of password authentication.

Step S613: The management client B configures the operation certificate, the access and control rights, etc. of device domain B for the cross-domain device. At this time, the cross-domain device is added to device domain B which includes a sensing device, the management client B, and an air conditioner.

Step S614: The cross-domain device updates multi-manager configuration parameter and increases the value of multi-manager configuration parameter by 1. The multi-manager configuration parameter indicates a number of management clients that have access to the cross-domain device.

Step S615: The air conditioner in device domain B sends to the cross-domain device a subscription request including an identification of device domain B and an identification of the air conditioner.

Step S616: The cross-domain device determines a number of currently established direct communication connections, and judges whether the number of connections of the cross-domain device reaches the maximum value N. If the number of current connections of the cross-domain device does not reach the maximum value N, a subscription success response is returned to the air conditioner.

Step S617: When the number of current connections of the cross-domain device reaches the maximum value N, it is further judged whether a number of direct communication connections from device domain B reaches a domain B threshold for device domain B (e.g., domain B threshold=¼*N). If so, a subscription failure response is returned, otherwise, the next step S618 is executed.

Step S618: The cross-domain device selects at least one member device (e.g., the lamp) in domain A, stops sending notification messages to the lamp within a maximum notification period, and deletes the subscription request of the lamp. The maximum notification period refers to the notification period of the conversation between the cross-domain device and a subscriber. For example, the notification period of the conversation is 10 minutes. If the subscriber does not receive the message for 10 minutes, it indicates that the subscriber is disconnected from the cross-domain device. In the present disclosure, the subscriber refers to a member device that has established a communication connection with the cross-domain device.

As shown in FIG. 6B, the door magnetic sensor disconnects the direct communication connection with the lamp in device domain A.

Step S619: The lamp in device domain A re-initiates a subscription request. In response to the subscription request, the cross-domain device judges whether the number of direct communication connections established with the cross-domain device reaches the maximum value N. Since the number of connections of the cross-domain device reaches the maximum value N at this time, it is further judged whether the subscription request reaches a domain A threshold for device domain A. If the subscription request reaches the domain A threshold for device domain A, the lamp selects a subscription proxy in device domain A and sends the subscription request to the subscription proxy. The subscription proxy sends a subscription request to the cross-domain device according to the subscription request of the lamp. The cross-domain device receives the subscription request of the subscription proxy, selects at least one subscriber (e.g., the water heater), stops sending notification messages to the water heater within the maximum notification period, and deletes the subscription request of the water heater.

As shown in FIG. 6C, the door magnetic sensor disconnects the direct communication connection with the water heater in device domain A.

Step S620: The water heater in device domain A repeats the previous step, and finally the water heater subscribes to the data information of the cross-domain device through the subscription proxy.

As shown in FIG. 6D, the water heater and the lamp are communicatively connected with the door magnetic sensor through the subscription proxy in device domain A.

Step S621: The cross-domain device returns a subscription success response to the air conditioner in device domain B. The subscription success response is used to inform the air conditioner that the communication connection has been successfully established.

Step S622: The cross-domain device sends data information to the air conditioner in device domain B.

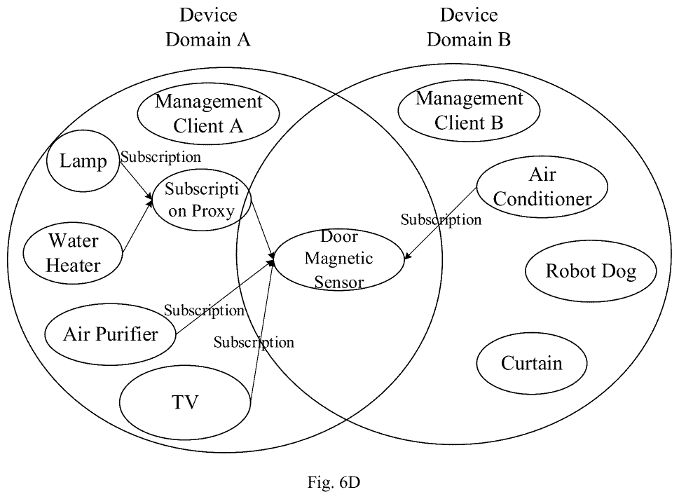

FIG. 7A shows a flowchart of a communication method provided by at least one embodiment of the present disclosure.

FIGS. 7B and 7C are schematic diagrams showing the communication method shown in FIG. 7A.

As shown in FIG. 7A, the communication method may include steps S701˜S722.

Step S701: A management client A discovers a cross-domain device (e.g., door magnetic sensor) and adds the cross-domain device to device domain A. At this time, device domain A includes a lamp, a water heater, the manager client and the cross-domain device.

Step S702: The lamp in device domain A sends to the cross-domain device a subscription request including an identification of device domain A and an identification of the lamp.

Step S703: A sensing device sends a subscription response to the lamp. For example, after receiving the subscription request of the lamp, the door magnetic sensor, in response to the state change of the door lock being closed, sends data information to the lamp indicating the lamp to turn off. The data information indicating the lamp to turn off is the subscription response.

Step S704: The water heater in device domain A sends to the cross-domain device a subscription request including the identification of device domain A and an identification of the water heater.

Step S705: The cross-domain device sends a subscription response to the water heater.

Step S706: The management client A sends a domain-number to the cross-domain device, so as to allow the domain-number of device domains to be added to the cross-domain device. For example, the number of domains is equal to 1.

Step S707: The management client A receives a parameter configuration response returned by the cross-domain device. The parameter configuration response, for example, notifies the management client that the configuration of the domain-number is successful or failed.

Step S708: The management client A sends to the sensing device an Open Commissioning Window request including a time range, so as to allow the domain-number of device domains to be added to the cross-domain device within the time range.

Step S709: The management client A receives a control response sent by the cross-domain device, wherein the control response is used to indicate whether the cross-domain device is successfully triggered to start opening commissioning, and when returning a success, the next step S710 is executed.

Step S710: The cross-domain device broadcasts a DNS-SD record.

Step S711: A management client B discovers the sensing device through DNS-SD. The management client B is a client for managing device domain B.

Step S712: The management client B establishes a secure connection with the cross-domain device. For example, the management client B establishes a PASE secure connection with the cross-domain device by means of password authentication.

Step S713: The management client B configures the operation certificate, the access and control rights, etc. of device domain B for the cross-domain device. At this time, the cross-domain device is added to device domain B which includes the sensing device, the management client B, and the air conditioner.

Step S714: The cross-domain device updates multi-manager configuration parameter and increases the value of multi-manager configuration parameter by 1. The multi-manager configuration parameter indicates a number of management clients that have access to the cross-domain device.

Step S715: The air conditioner and a robot dog in device domain B send to the cross-domain device respectively, subscription requests including an identification of device domain B, an identification of the air conditioner, or an identification of the robot dog.

Step S716: The cross-domain device judges whether a number of direct communication connections from device domain B reaches the domain B threshold for device domain B (e.g., domain B threshold=½*N). If the number of direct communication connections of device domain B does not reach the domain B threshold, a subscription success response is returned. Otherwise, the next step S718 is executed.

Step S717: A curtain in device domain B sends to the cross-domain device a subscription request including the identification of device domain B and an identification of the curtain. In response to receiving the subscription request of the curtain, the cross-domain device executes step S716.

Step S718: It is further judged whether the curtain is a subscription proxy. If the curtain is not the subscription proxy, a subscription failure response is returned, and the next step S719 is executed.

As shown in FIG. 7B, if the number of direct communication connections from device domain B reaches the domain B threshold, and the curtain is not the subscription proxy, a subscription failure response is sent to the curtain.

If the curtain is the subscription proxy, a subscription success response is returned, and the cross-domain device selects at least one subscriber (e.g., the robot dog) in device domain B, stops sending notification messages to the robot dog within the maximum notification period, and deletes the subscription request of the robot dog.

Step S719: The curtain searches for a subscription proxy, and sends a subscription request to the cross-domain device through the subscription proxy.

Step S720: The curtain establishes a communication connection with the cross-domain device through the subscription proxy, so as to acquire data information from the cross-domain device.

Step S721: The robot dog searches for a subscription proxy, and sends a subscription request to the sensing device through the subscription proxy.

Step S722: The robot dog establishes a communication connection with the cross-domain device through the subscription proxy, so as to acquire data information from the cross-domain device.

As shown in FIG. 7C, the robot dog and the curtain are communicatively connected with the door magnetic sensor through the subscription proxy in device domain B.

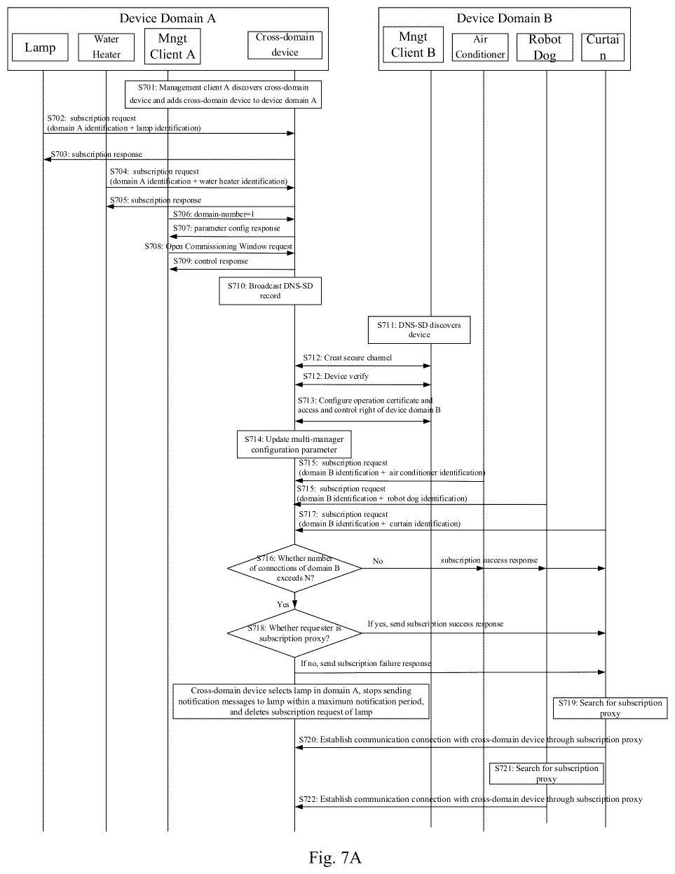

In other embodiments of the present disclosure, the cross-domain device is used to receive data from the member devices. Due to the limited ability of the cross-domain device to receive data, it is difficult for the cross-domain device to receive data information of a large number of member devices at the same time. The member devices in the same device domain may establish a connection with the cross-domain device and send data information, by means of preemption, sequencing, etc. The cross-domain device may display data information provided by different device domains at the same time, for example. In this embodiment, there may be no subscription proxy. FIG. 8A shows a flowchart of the communication method of this embodiment.

FIG. 8A shows a flowchart of a communication method provided by at least one embodiment of the present disclosure.

FIG. 8B is a schematic diagram showing the communication method shown in FIG. 8A.

As shown in FIG. 8A, the communication method may include steps S801˜S822.

Step S801: A management client C discovers a cross-domain device (e.g., display device) and adds the display device to device domain C. At this time, device domain C includes a front door camera, a bedroom camera, a manager client C and the display device.

Step S802: The front door camera in device domain C sends to the display device a subscription request including an identification of device domain C and an identification of the front door camera;

Step S803: The display device sends a transmission response to the front door camera.

Step S804: The bedroom camera in device domain C sends to the display device a transmission request including the identification of device domain C and an identification of the bedroom camera.

Step S805: The display device sends a subscription response to the bedroom camera.

Step S806: The management client C sends a domain-number to the display device, so as to allow the domain-number of device domains to be added to the display device. For example, the domain-number is equal to 1.

Step S807: The management client C receives a parameter configuration response returned by the display device. The parameter configuration response, for example, notifies the management client that the configuration of the domain-number is successful or failed.

Step S808: The management client C sends to the display device an Open Commissioning Window request including a time range, so as to allow the domain-number of device domains to be added to the display device within the time range.

Step S809: The management client C receives a response sent by the display device, wherein the response is used to indicate whether the display device is successfully triggered to start opening commissioning, and when the response is successful, the next step S810 is executed.

Step S810: The display device broadcasts a DNS-SD record.

Step S811: A management client D discovers a sensing device through DNS-SD. The management client D is a client for managing device domain D.

Step S812: The management client D establishes a secure connection with the display device. For example, the management client D establishes a PASE secure connection with the display device by means of password authentication.

Step S813: The management client D configures the operation certificate, the access and control right, etc., of device domain D for the display device. At this time, the display device is added to device domain D which includes the display device, the manager client D, a back door camera, and a bedroom TV.

Step S814: The display device updates multi-manager configuration parameter and increases the value of multi-manager configuration parameter by 1. The multi-manager configuration parameter indicates a number of management clients that have access to the display device.

Step S815: The back door camera in device domain D sends to the display device a transmission request including an identification of device domain D and an identification of the back door camera.

Step S816: The display device judges whether a number of current transmission requests reaches a maximum value N of communication connections that the display device can establish. If the number of current transmission requests does not reach the maximum value N of communication connections that the display device can establish, a transmission success response is returned.

If the number of current transmission requests reaches the maximum value N of communication connections that the display device can establish, step S817 is further executed.

Step S817: It is judged whether the number of transmission requests from device domain D reaches a domain D threshold (e.g., domain D threshold=½*N).

If the number of transmission requests from device domain D reaches the domain D threshold, a transmission failure response is returned. If the number of transmission requests from device domain D does not reach the domain D threshold, the next step S818 is executed.

Step S818: A communication connection is disconnected between a member device with a lower priority in device domain C and the display device, a communication connection with the back door camera is established, and a transmission success response is returned to the back door camera.

As shown in FIG. 8B, the display device (i.e., living room TV) disconnects the direct communication connection with the front door camera in device domain C, and establishes the direct communication connection with the rear door camera in device domain D.

At least one embodiment of the present disclosure provides another communication method applied to a cross-domain device, wherein the cross-domain device is configured to establish communication connections with member devices in multiple device domains at the same time, and the multiple device domains include a first domain, the method comprising: making a number of direct communication connections established with the cross-domain device less than or equal to a first domain threshold for the first domain.

For example, a cross-domain device can establish at most N direct communication connections, where N is an integer greater than 0, and the threshold for each device domain is less than N, and then the cross-domain device can guarantee to establish communication connections with member devices in multiple device domains at the same time, thus alleviating the problem that the member devices in some device domains in FIG. 1A and FIG. 1B cannot establish communication connection with the cross-domain device.

In some embodiments of the present disclosure, the cross-domain device is made to be communicatively connected with at least two member devices in the first domain through the proxy device in the first domain.

As shown in FIG. 3A, the proxy device may be a member device installed with a subscription proxy, and the member device, i.e., the lamp and water heater, in device domain A are communicatively connected with the door magnetic sensor through the subscription proxy.

As shown in FIG. 3B, the proxy device may be a member device installed with a transmission proxy, and the member devices, i.e., the back door camera and bedroom TV, in device domain B are communicatively connected with the door magnetic sensor through the transmission proxy.

As mentioned above in the present disclosure, the proxy device may be any member device installed with a proxy program or transmission program in the device domain.

Through the proxy device, the cross-domain device is made to be communicatively connected to at least two member devices in the first domain, so that the number of direct communication connections of the cross-domain device can be reduced, and more member devices can be communicatively connected with the cross-domain device.

In some embodiments of the present disclosure, the cross-domain device is made to be communicatively connected with at least two member devices in the first domain through the proxy device in the first domain, in response to the number of direct communication connections in the first domain established with the cross-domain device reaching the first domain threshold for the first domain.

In some embodiments of the present disclosure, communicatively connecting with at least two member devices in the first domain through the proxy device in the first domain comprises: receiving a connection request, and determining whether to respond to the connection request according to a type of the requester initiating the connection request.

If the number of direct communication connections in the first domain established with the cross-domain device reaches the first domain threshold for the first domain, it is determined whether to respond to the connection request according to the type of the requester initiating the connection request.

In some embodiments of the present disclosure, the at least two member devices include a first device. Determining whether to respond to the connection request according to the type of the requester initiating the connection request comprises: establishing a direct communication connection with the proxy device in response to the requester being the proxy device, wherein the first device is communicatively connected with the proxy device; refusing to establish a communication connection with the requester in response to the requester not being the proxy device.

In some embodiments of the present disclosure, the at least two member devices further include a second device. Responding to the connection request being communicatively connected with the proxy device, in response to the requester being the proxy device, comprises: disconnecting the direct communication connection between the second device and the cross-domain device; and establishing a direct communication connection with the proxy device.

In some embodiments of the present disclosure, communicatively connecting with at least two member devices in the first domain through the proxy device in the first domain further comprises: determining, after receiving the connection request, whether the number of direct communication connections in the first domain established with the cross-domain device reaches the first domain threshold; responding to the connection request in response to the number of direct communication connections in the first domain established with the cross-domain device not reaching the first domain threshold.

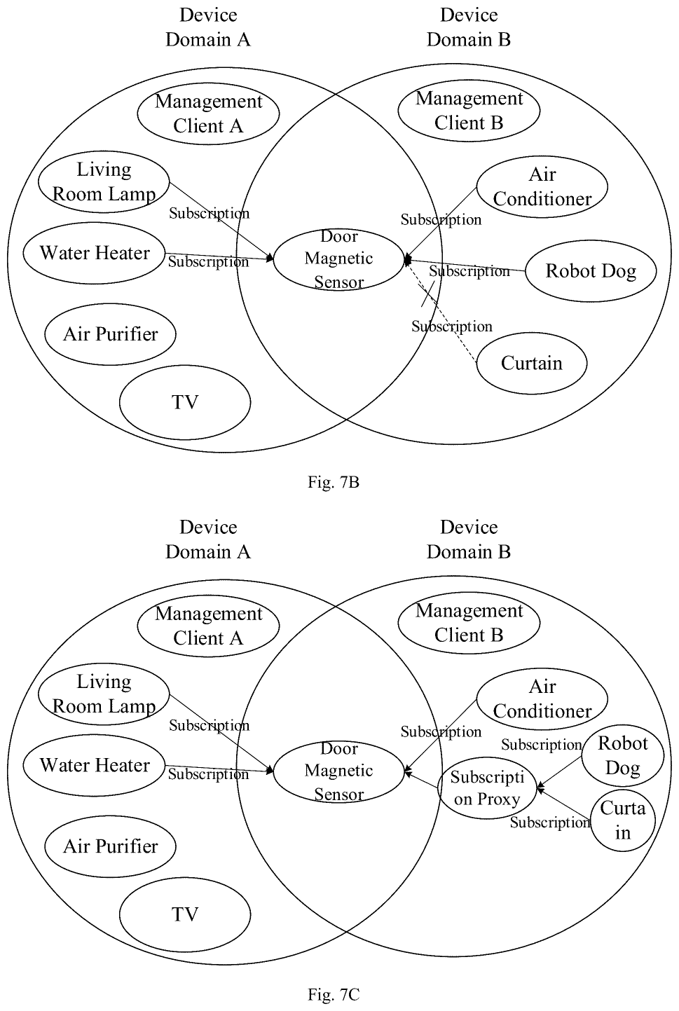

FIG. 9 shows a schematic block diagram of a communication apparatus 900 provided by at least one embodiment of the present disclosure. The communication apparatus 900 is applied to a cross-domain device, wherein the cross-domain device is configured to establish communication connection with member devices in multiple device domains, and the multiple device domains include a first domain.

For example, as shown in FIG. 9, the communication apparatus 900 includes a request acquisition unit 910, a threshold determination unit 920 and a response unit 930.

The request acquisition unit 910 is configured to acquire a connection request.

The request acquisition unit 910 may, for example, execute step S10 described in FIG. 2.

The threshold determination unit 920 is configured to determine, according to the connection request, that a requester of the connection request is a member device in the first domain and determine a first domain threshold for the first domain.

The threshold determination unit 920 may, for example, execute step S20 described in FIG. 2.

The response unit 930 is configured to determine whether to establish a communication connection with the requester according to the connection request, in response to a number of direct communication connections established between member devices in the first domain and the cross-domain device reaching the first domain threshold.

The response unit 930 may, for example, execute step S30 described in FIG. 2.

For example, the request acquisition unit 910, the threshold determination unit 920 and the response unit 930 may be hardware, software, firmware and any feasible combination thereof. For example, the request acquisition unit 910, the threshold determination unit 920, and the response unit 930 may be dedicated or universal circuit, chip, apparatus, etc., or may be a combination of a processor and a memory. With regard to the specific implementation forms of the above-mentioned units, the embodiments of the present disclosure does not limit to this.

It should be noted that in the embodiments of the present disclosure, respective units of the communication apparatus 900 corresponds to respective steps of the aforementioned communication method, and the specific functions of the communication apparatus 900 can be referred to the relevant description of the communication method, which will not be detailed here. The components and structures of the communication apparatus 900 shown in FIG. 9 are only exemplary, but not restrictive, and the communication apparatus 900 may further include other components and structures as required.

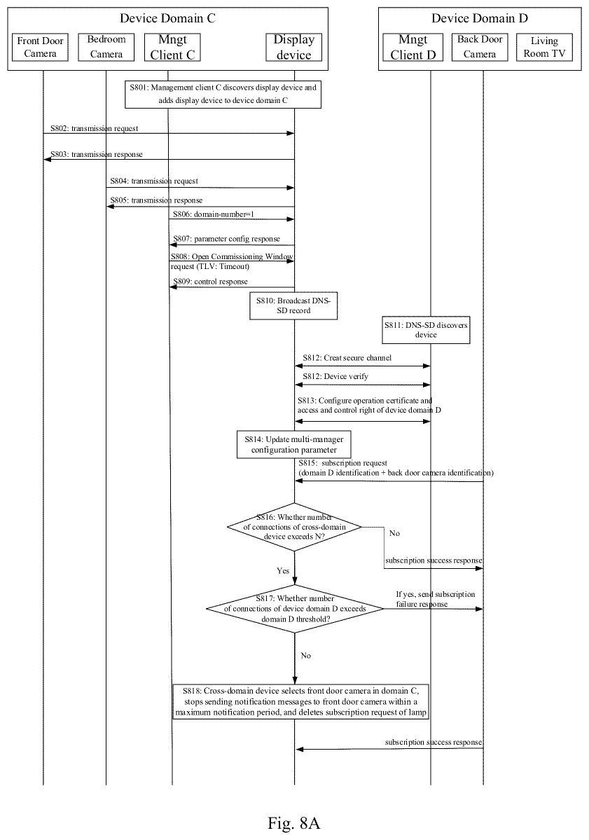

FIG. 10 shows a schematic block diagram of a communication apparatus 1000 provided by at least one embodiment of the present disclosure. The communication apparatus 1000 is applied to a cross-domain device, wherein the cross-domain device is configured to establish communication connection with member devices in multiple device domains, and the multiple device domains include a first domain.

For example, as shown in FIG. 10, the communication apparatus 1000 includes a control unit 1010.

The control unit 1010 is configured to make a number of direct communication connections established with the cross-domain device less than or equal to a first domain threshold for the first domain.

At least one embodiment of the present disclosure further provides an electronic device comprising a processor and a memory. The memory includes one or more computer program instructions. The one or more computer program instructions are stored in the memory and configured to be executed by the processor. The one or more computer program instructions include instructions for implementing the communication method described above. The electronic device can coordinate member devices connected with the cross-domain device, thereby improving the flexibility of communication connection between member devices in multiple device domains and the cross-domain device.

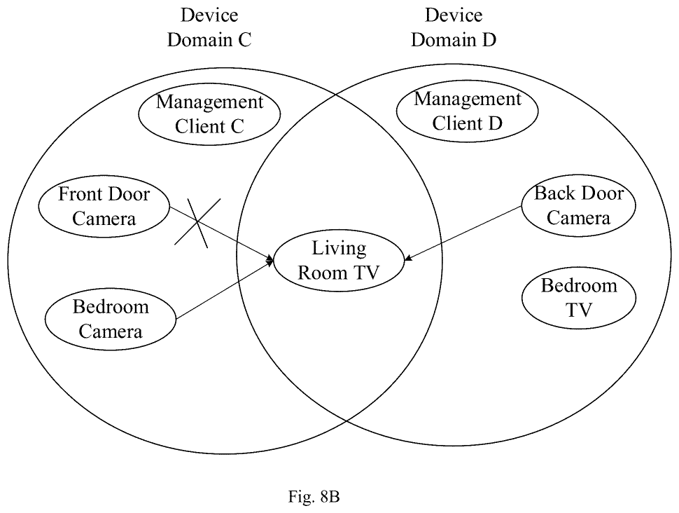

FIG. 11 is a schematic block diagram of an electronic device provided by some embodiments of the present disclosure. As shown in FIG. 11, the electronic device 1100 includes a processor 1110 and a memory 1120. The memory 1120 is used to store non-transitory computer-readable instructions (e.g., one or more computer program modules). The processor 1110 is used to execute non-transitory computer-readable instructions, which, when executed by the processor 1110, can execute one or more steps of the communication method described above. The memory 1120 and the processor 1110 may be interconnected through a bus system and/or other forms of connection mechanisms (not shown).

For example, the processor 1110 may be central processing unit (CPU), graphics processing unit (GPU) or other forms of processing units with data processing capability and/or program executing capability. For example, the central processing unit (CPU) may be X86 or ARM architecture. The processor 1110 may be a general-purpose or special-purpose processor, and may control other components in the electronic device 1100 to perform desired functions.

For example, the memory 1120 may include any combination of one or more computer program products, which may include various forms of computer-readable storage media, such as volatile memory and/or nonvolatile memory. The volatile memory may include, for example, random access memory (RAM) and/or cache, etc. The non-volatile memory may include, for example, read-only memory (ROM), hard disk, erasable programmable read-only memory (EPROM), portable compact disk read-only memory (CD-ROM), USB memory, flash memory, etc. One or more computer program modules may be stored on a computer-readable storage medium, and the processor 1110 may execute one or more computer program modules to implement various functions of the electronic device 1100. The computer-readable storage medium may also store various application programs and various data, as well as various data used and/or generated by the application programs, etc.

It should be noted that, in the embodiments of the present disclosure, the specific functions and technical effects of the electronic device 1100 can refer to the above description with regard to the communication method, and will not be detailed here.

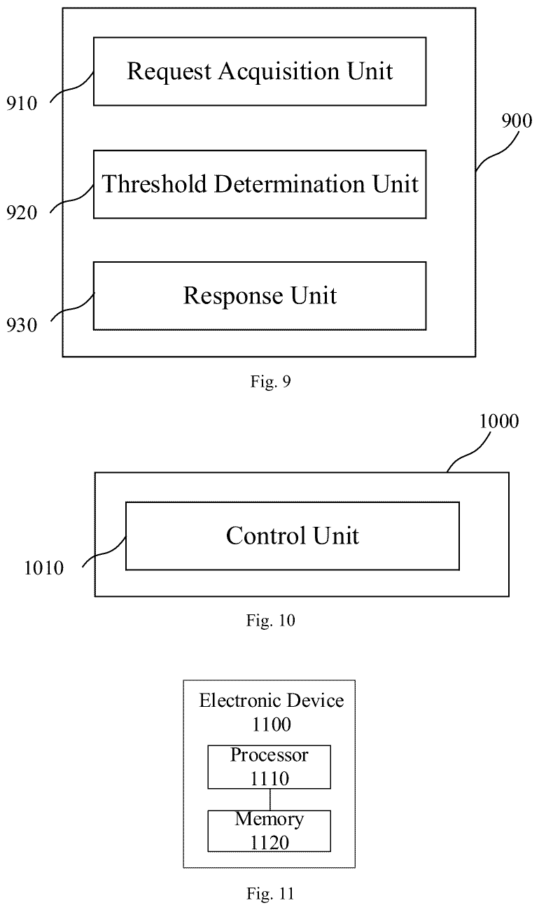

FIG. 12 is a schematic block diagram of another electronic device provided by some embodiments of the present disclosure. The electronic device 1200 is, for example, suitable for implementing the communication method provided by the embodiments of the present disclosure. The electronic device 1200 may be a terminal device or the like. It should be noted that the electronic device 1200 shown in FIG. 12 is only an example, and it will not bring any restrictions on the functions and application scope of the embodiments of the present disclosure.

As shown in FIG. 12, the electronic device 1200 may include a processing apparatus (such as central processing unit, graphics processor, etc.) 1210, which may perform various appropriate actions and processes according to programs stored in a read-only memory (ROM) 1220 or programs loaded from a storage 1280 into a random access memory (RAM) 1230. The RAM 1230 stores various programs and data required for the operations of the electronic device 1200. The processing apparatus 1210, the ROM 1220 and the RAM 1230 are connected to each other through a bus 1240. An input/output (I/O) interface 1250 is also connected to the bus 1240.

Generally, the following apparatuses may be connected to the I/O interface 1250: an input apparatus 1260 including, for example, touch screen, touch pad, keyboard, mouse, camera, microphone, accelerometer, gyroscope, etc.; an output apparatus 1270 including, for example, liquid crystal display (LCD), speaker, vibrator, etc.; a storage 1280 including, for example, magnetic tape, hard disk, etc.; and a communication apparatus 1290. The communication apparatus 1290 may allow the electronic device 1200 to perform wireless or wired communication with other electronic devices to exchange data. Although FIG. 12 shows an electronic device 1200 with various apparatuses, it should be understood that not all the apparatuses shown are required to be implemented or provided, and the electronic device 1200 can be implemented or provided with more or less apparatuses instead.

For example, according to an embodiment of the present disclosure, the communication method described above can be implemented as a computer software program. For example, an embodiment of the present disclosure includes a computer program product including a computer program carried on a non-transient computer-readable medium, wherein the computer program product includes program code for executing the communication method described above. In such an embodiment, the computer program may be downloaded and installed from the network through the communication apparatus 1290, or installed from the storage 1280, or installed from the ROM 1220. When the computer program is executed by the processing apparatus 1210, the functions defined in the communication method provided by the embodiments of the present disclosure can be implemented.

At least one embodiment of the present disclosure further provides a computer-readable storage medium for storing non-transitory computer-readable instructions, which, when executed by a computer, can implement the communication method described above. The computer-readable storage medium can be utilized to coordinate member devices connected with a cross-domain device, thereby improving the flexibility of communication connection between member devices in multiple device domains and the cross-domain device.

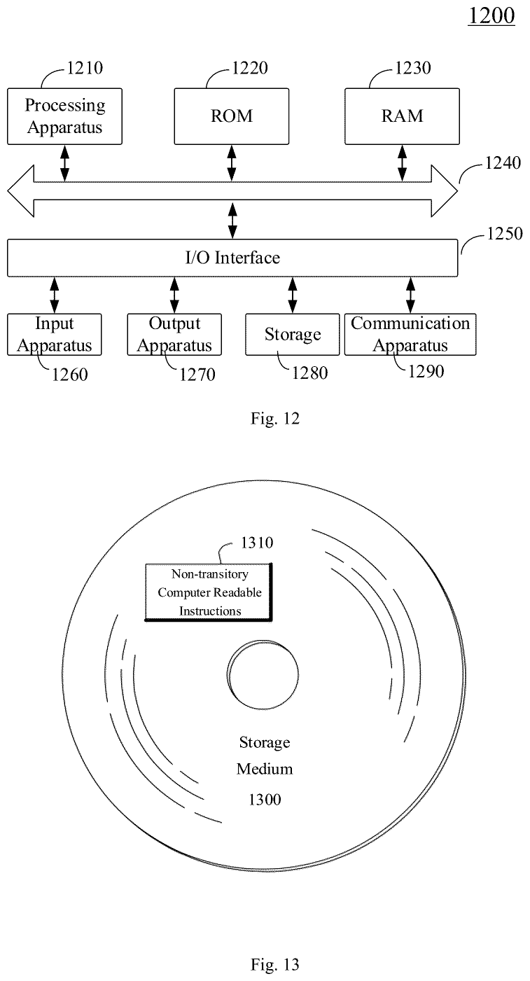

FIG. 13 is a schematic diagram of a storage medium provided by some embodiments of the present disclosure. As shown in FIG. 13, the storage medium 1300 is used to store non-transitory computer-readable instructions 1310. For example, the non-transitory computer-readable instructions 1310, when executed by a computer, can execute one or more steps in the communication method described above.

For example, the storage medium 1300 may be applied to the above electronic device 1100. For example, the storage medium 1300 may be the memory 1120 in the electronic device 1100 shown in FIG. 11. For example, the illustrations with regard to the storage medium 1300 can refer to the corresponding description of the memory 1120 in the electronic device 1100 shown in FIG. 11, and will not be detailed here.

There are several points required to be illustrated, as follows:

(1) The accompanying drawings of the embodiments of the present disclosure only relate to the structures involved in the embodiments of the present disclosure, and other structures can refer to common designs.
(2) In the case of no conflict, the embodiments of the present disclosure and the features in the embodiments can be combined with each other to obtain new embodiments.

The above is only the specific implementations of the present disclosure, but the protection scope of the present disclosure is not limited to this, and the protection scope of the present disclosure should be subject to the protection scope of the claims.

1. A communication method applied to a cross-domain device, wherein the cross-domain device is configured to establish communication connections with member devices in multiple device domains, and the multiple device domains includes a first domain, the method comprising:
acquiring a connection request;
determining, according to the connection request, that a requester of the connection request is a member device in a first domain and determine a first domain threshold for the first domain;
determining whether to establish a communication connection with the requester according to the connection request, in response to a number of direct communication connections established between member devices in the first domain and a cross-domain device reaching the first domain threshold.

2. The method according to claim 1, wherein determining whether to establish a communication connection with the requester according to the connection request, in response to a number of direct communication connections established between member devices in the first domain and a cross-domain device reaching the first domain threshold, the method comprising:
judging whether the requester is a proxy device according to the connection request, in response to the number of direct communication connections established between member devices in the first domain and the cross-domain device reaching the first threshold;
establishing a communication connection with the requester in response to the requester being the proxy device.

3. The method according to claim 2, wherein the first domain includes a first device, and the first device is directly communicatively connected with the cross-domain device,
responding to the connection request in response to the requester being the proxy device comprises:
disconnecting the direct communication connection between the first device and the cross-domain device in response to the requester being the proxy device; and
establishing a direct communication connection between the proxy device and the cross-domain device;
wherein the first device reconnects communicatively with the cross-domain device through one of proxy devices in the first domain.

4. The method according to claim 2, further comprising:
in response to the requester being not a proxy device, refusing to establish a direct communication connection with the requester, communicatively connecting by the requester with any proxy device in the first domain, and communicatively connecting with the cross-domain device through the proxy device.

5. The method according to claim 1, further comprising:
establishing a communication connection between the requester and a cross-domain device, in response to the number of direct communication connections in the first domain established with the cross-domain device not reaching the first domain threshold.

6. The method according to claim 5, wherein the cross-domain device establishes at most N direct communication connections, where N is an integer greater than 0,
establishing a communication connection between the requester and a cross-domain device, in response to the number of direct communication connections in the first domain established with the cross-domain device not reaching the first domain threshold comprises:
selecting a third device from a second domain, in response to the number of direct communication connections established with the cross-domain device reaching the N, and disconnecting the communication connection between the third device and the cross-domain device; and
establishing a communication connection between the requester and the cross-domain device,
wherein the third device is communicatively connected with a proxy device in the second domain, and the third device is communicatively connected with the cross-domain device through the proxy device in the second domain.

7. The method according to claim 1, wherein the cross-domain device establishes at most N direct communication connections, where N is an integer greater than 0,
determining, according to the connection request, that a requester of the connection request is a member device in a first domain and determine a first domain threshold for the first domain, comprises:
determining, according to the connection request, that the requester of the connection request is a member device in the first domain and determining the first domain threshold for the first domain, in response to the number of direct communication connections established with the cross-domain device reaching the N.

8. The method according to claim 1, further comprising:
acquiring configuration parameters for allowing the multiple device domains to establish communication connection with the cross-domain device;
broadcasting a record of domain name system service discovery in response to the configuration parameters, to allow the multiple device domains to discover the cross-domain device;
receiving an authentication request of the at least one device domain, and adding the at least one device domain to the cross-domain device, to allow a plurality of member devices in the at least one device domain to establish communication connection with the cross-domain device.

9. The method according to claim 8, wherein receiving an authentication request of the at least one device domain, and adding the at least one device domain to the cross-domain device, to allow a plurality of member devices in the at least one device domain to establish communication connection with the cross-domain device, the method comprising:
receiving an authentication request of the at least one device domain, and establishing a connection with a management client in the at least one device domain based on the authentication request;
acquiring configuration information from the management client in the at least one device domain, and configuring access rights for member devices in the at least one device domain to the cross-domain device according to the configuration information.

10. The method according to claim 8, wherein the configuration parameters include a time range and a domain-number of device domains establishing communication connections with the cross-domain device,
the domain-number of device domains are allowed to be added to the cross-domain device within the time range.

11. The method according to claim 1, wherein the connection request includes an identification of a device domain and an identification of the requester,
determining, according to the connection request, that a requester of the connection request is a member device in a first domain and determine a first domain threshold for the first domain, comprises:
determining the first domain to which the requester belongs and the first threshold for the first domain according to the identification of the device domain.

12. The method according to claim 2, wherein the connection request includes a type of the requester,
judging whether the requester is a proxy device, in response to the number of direct communication connections in the first domain established with the cross-domain device reaching the first threshold, comprising:
judging whether the requester is a proxy device according to the type of the requester, in response to the number of direct communication connections in the first domain established with the cross-domain device reaching the first threshold.

13. The method according to claim 2, wherein the cross-domain device receives data information from member devices in the multiple device domains; or
the cross-domain device provides data information to member devices in the multiple device domains;
wherein, in the case where the cross-domain device receives the data information from member devices in the multiple device domains, after the proxy device establishes a direct communication connection with the cross-domain device, the proxy device is configured to receive the data information from member devices communicatively connected with the proxy device, and provide the data information to the cross-domain device;
in the case where the cross-domain device provides data information to member devices in the multiple device domains, after the proxy device establishes a direct communication connection with the cross-domain device, the proxy device is configured to receive the data information from the cross-domain device and provide the data information to member devices communicatively connected with the proxy device.

14. The method according to claim 1, wherein the cross-domain device includes a sensor configured to sense a state of a target object, and the connection request includes a subscription request,
the method further comprises:
after the cross-domain device establishes a direct communication connection with the requester in response to the subscription request, sending data information to the requester to control the requester, in response to the sensor sensing a state change of the target object.

15. The method according to claim 1, wherein the cross-domain device includes a display device configured to display data information;
the method further comprises:
displaying data information from the requester in response to the cross-domain device establishing a direct communication connection with the requester.

16. A communication method applied to a cross-domain device, wherein the cross-domain device is configured to establish communication connections with member devices in multiple device domains at the same time, and the multiple device domains includes a first domain, the method comprising:
making a number of direct communication connections established with the cross-domain device less than or equal to a first domain threshold for the first domain.

17. The method according to claim 16, wherein making a number of direct communication connections established with the cross-domain device less than or equal to a first domain threshold for the first domain comprises:
making the cross-domain device to be communicatively connected with at least two member devices in the first domain through the proxy device in the first domain,
wherein, making the cross-domain device to be communicatively connected with at least two member devices in the first domain through the proxy device in the first domain, in response to the number of direct communication connections in the first domain established with the cross-domain device reaching the first domain threshold for the first domain,
wherein communicatively connecting with at least two member devices in the first domain through the proxy device in the first domain comprises: receiving a connection request, and determining whether to respond to the connection request according to a type of the requester initiating the connection request.

18-19. (canceled)

20. The method of claim 17, wherein the at least two member devices include a first device and a second device,
determining whether to respond to the connection request according to a type of the requester initiating the connection request comprises:
establishing a direct communication connection with the proxy device in response to the requester being the proxy device, wherein the first device is communicatively connected with the proxy device;
refusing to establish a communication connection with the requester in response to the requester not being the proxy device,
wherein, responding to the connection request being communicatively connected with the proxy device, in response to the requester being the proxy device, comprises: disconnecting the direct communication connection between the second device and the cross-domain device; and establishing a direct communication connection with the proxy device.

21. (canceled)

22. The method according to claim 17, wherein communicatively connecting with at least two member devices in the first domain through the proxy device in the first domain further comprises:
determining, after receiving the connection request, whether the number of direct communication connections in the first domain established with the cross-domain device reaches the first domain threshold;
wherein responding to the connection request in response to the number of direct communication connections in the first domain established with the cross-domain device not reaching the first domain threshold.

23-24. (canceled)

25. An electronic device, comprising:
a processor;
a memory including one or more computer program instructions;
wherein the one or more computer program instructions are stored in the memory and, when executed by the processor, implement the communication method according to claim 1.

26. (canceled)
